(19) United States
(12) Patent Application Publication
(10) Pub. No.: US 2009/0249100 A1
(43) Pub. Date: Oct. 1, 2009

(54) CIRCUIT SYSTEM

(75) Inventor: Katsuhiko TAKEUCHI, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki; Kanagawa (JP)

(21) Appl. No.: 12/411,331

(22) Filed: Mar. 25, 2009

(30) Foreign Application Priority Data
Mar. 26, 2008 (JP) 2008-080592

(51) Int. Cl. G06F 1/32

(52) U.S. Cl. 713/323; 713/320

(57) ABSTRACT

One aspect of the embodiment is related to a circuit system having multiple circuit blocks each of which operates upon reception of power supply. The circuit system includes multiple circuit blocks each of which operates upon reception of power, multiple switch elements which are provided respectively to the multiple circuit blocks and each of which supplies and cuts off power to the corresponding circuit block upon reception of control and a power control unit that controls each of the multiple switch elements to cause the switch element to supply and cut off power to the corresponding circuit block.

### CROSS-REFERENCE TO RELATED APPLICATIONS

This application is based upon and claims the benefit of priority of the prior Japanese Laid-open Patent No. 2008-080592, filed on Mar. 26, 2008, the entire contents of which are incorporated herein by reference.

### FIELD

The embodiment is related to a circuit system having multiple circuit blocks each of which operates upon reception of power supply, and to a program storage device that stores a program to be executed in the circuit system.

### BACKGROUND

Recently, in electronic equipment of various types, attention has been focused on energy savings, that is, reduction in power consumption.

For example, a system LSI to be incorporated in a hard disk device includes multiple circuit blocks which operate in synchronization with a clock provided from a clock resource. Heretofore, in the system LSI, an approach to reduce power consumption has been made in which the clock provided from its clock resource is reduced in speed or stopped.

However, an increase in leakage power supply due to recent improvement in circuit miniaturization technique and an increase in switching current due to a higher speed of an operation clock make the existing method insufficient as a power saving measure. For example, a problem arises in which a hard disk device for a laptop computer cannot be used for a long time by using a battery. Moreover, in a hard disk device for a desktop server, there is a possibility that measures for a facility is needed, for example, a cooling device for preventing heat generation is required therefor.

Here, Japanese Laid-open Patent Publication No. 2004-128590 (Patent Document 1) discloses a level shifter circuit that generates no through current even when power supply is cut off in a semiconductor integrated circuit that is operated by multiple power supplies having different voltages, in order to achieve lower power consumption. Moreover, Japanese Laid-open Patent Publication No. 2007-150987 (Patent Document 2) discloses a technique of stabilizing an output from an I/O port output terminal even when an output from a low-potential power supply is reduced in a multi-power supply microcomputer system using power supplies of two types or more.

The techniques disclosed in Patent Documents 1 and 2 may be helpful in achieving lower power consumption and stabilization of an output. However, they are insufficient techniques from the viewpoint that how power consumption is reduced while implementing high functional operations in the entire circuit system.

### SUMMARY

A circuit system includes plural circuit blocks each of which operates upon reception of power, plural switch elements which are provided respectively to the plural circuit blocks, and each of which supplies and cuts off power to the corresponding circuit block upon reception of control and a power control unit that controls each of the plural switch elements to cause the switch element to supply and cut off power to the corresponding circuit block.

Objects and advantages of the invention will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a block diagram showing a circuit configuration of a system LSI for a hard disk, which is one embodiment of a circuit system;

FIG. 2 is a view showing one example of a memory address map seen from a CPU;

FIG. 3 is a flowchart showing a first example at the time when power supply is cut off and restarted;

FIG. 4 is a flowchart showing a second example at the time when power supply is cut off and restarted;

FIGS. 5A to 5C are views showing a configuration of power supply cutoff of a RAM; and

FIG. 6 is an explanatory view of rewriting of a region where a boot address is stored.

### DESCRIPTION OF EMBODIMENT(S)

An embodiment of a circuit system and a program storage device disclosed in the present invention will be described below.

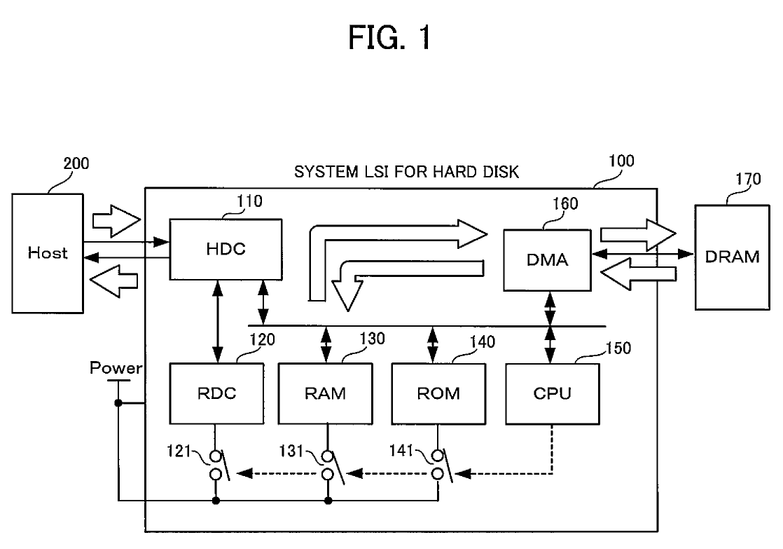

FIG. 1 is a block diagram showing a circuit configuration of a system LSI for a hard disk, which is an embodiment of the circuit system.

A system LSI 100 illustrated in FIG. 1 constitutes one integrated circuit and is contained in one semiconductor package. The system LSI 100 includes a hard disk controller (HDC) 110, a read channel (RD) 120, a RAM 130, a ROM 140, a CPU 150, and a DMA 160. Moreover, a host 200 and a dynamic RAM (DRAM) 170 are illustrated outside the system LSI 100. Note that, in addition to the circuit blocks illustrated in FIG. 1, the system LSI 100 includes an interface that transmits and receives a signal between itself and a head that accesses a disk being a storage medium built in a hard disk device (not illustrated), and an interface that outputs a signal to instruct driving of a spindle motor that rotates the disk built in the hard disk device or that of a voice coil motor that positions the head. However, illustrations and detailed description thereof will be omitted here.

The HDC 110 is a circuit block that communicates with the host 200 to receive a writing instruction on the disk, data for writing thereon, a reading instruction or the like from the host 200, and to transmit, to the host 200, data read from the disk.

The RDC 120 is a circuit block that serves to convert data for writing received from the HDC 110 into a signal to be transmitted to the header and transmit it to the head at the time of writing data. Also, at the time of reading data, the RDC 120 serves to receive a signal picked up by the head and convert a signal format of the signal into a reading signal, and transmit it to the HDC 110.

The RAM 130 is a volatile memory that is used as a buffer that temporarily stores data for writing which the HDC 110 has received from the host 200, a buffer that temporarily stores data to be transmitted to the host 200, and a working area for a program that is executed by the CPU 150.

The ROM 140 is a non-volatile memory that stores a program to be executed by the CPU 150, a fixed constant and the like.

The CPU 150 serves to execute the program to control the entire system LSI 100.

Moreover, the DMA 160 is a circuit block having a function of directly transferring data between the RAM 130 and the DRAM 170 without the CPU 150 upon reception of an instruction from the CPU 150.

Here, power is supplied to the respective circuit blocks that constitute the system LSI 100 and each circuit block operates by the supplied power. In particular, the RDC 120, the RAM 130 and the ROM 140 are provided with switch elements 121, 131, and 141 on the respective power supply lines, and power is supplied or cut off individually through these switches on the basis of an instruction from the CPU 150.

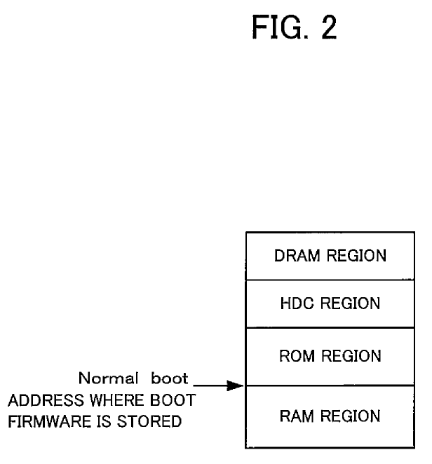

FIG. 2 is a view showing one example of a memory address map seen from the CPU.

Here, a RAM region, a ROM region, an HDC region, and a DRAM region are allocated in the order of addresses from the newest, and a head address of a region, where boot firmware is stored, is stored at a head address for the ROM region.

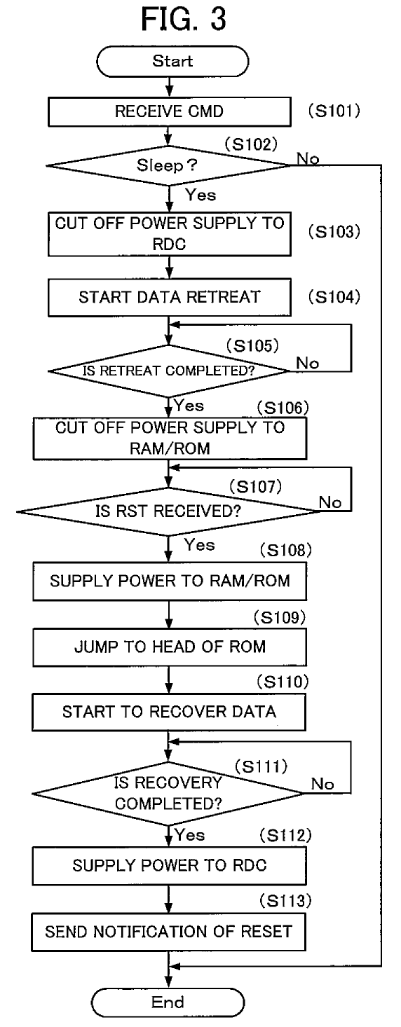

FIG. 3 is a flowchart showing a first example at the time when a power supply is cut off and restarted.

In ATA (Advanced Technology Attachment), which is a typical protocol used in the hard disk device, some commands for power down are prepared. Hereinafter, a description is given of the procedure of power cutoff upon reception of a sleep command instruction and that of power reset upon reception of a reset command instruction, the sleep command and the reset command each being one of the commands described above.

In the case of the sleep command, the power supply may be reset within some seconds. Here, the power supply to all the circuit blocks of the RDC 120, the RAM 130, and the ROM 140 illustrated in FIG. 1 is cut off.

First, when the HDC 110 receives a command, the command is transmitted to the CPU 150 (step S101), and then it is determined whether or not the command is a sleep command (step S102). The flowchart illustrated in FIG. 3 indicates processing to be performed upon reception of the sleep command, and upon reception of a command other than the sleep command, nothing is done and processing passes through this flow.

When the received command is a sleep command, processing goes to step S103 and the power supply to the RDC 120 is cut off, and then data stored in the RAM 130 is retreated to the DRAM 170 by the DMA 160 having received an instruction from the CPU 150 (step S104). When the retreat is completed (step S105), the power supply to the RAM 130 and the ROM 140 is cut off (step S106).

In other words, the power supply to all the circuit blocks of the RDC 120, the RAM 130, and the ROM 140 are cut off here.

When a reset command is next received from the host 200 (step S107), power is supplied to the RAM 130 and the ROM 140 (step S108) and steps of the program to be processed by the CPU 150 jump to the head of the ROM 140 (see FIG. 2) (step S109). Then, the DMA 160 performs data recovery of the RAM 130 by transferring the data retreated in the DRAM 170 to the RAM 130 (step S110). When the data recovery is completed (step S111), power is supplied to the RDC 120 (step S112) and a notification of reset is transmitted to the host 200 (step S113).

In this case, some time is required between the time when the reset command is received from the host 200 and the time when the reset is made. However, the power supply to all the circuit blocks of the RDC 120, the RAM 130, and the ROM 140 is cut off, and therefore it is possible to greatly reduce power consumption.

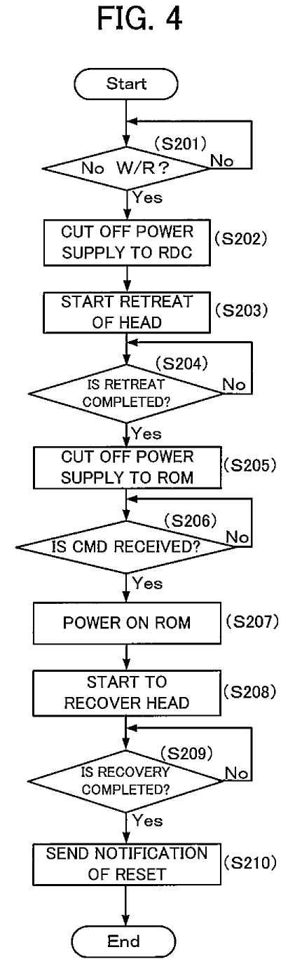

FIG. 4 is a flowchart showing a second example at the time when a power supply is cut off and restarted.

Particularly, in the hard disk device used in a so-called notebook personal computer or the like, due to necessity to achieve long-time driving using a battery, it is preferable that the system LSI 100 be powered down by its own decision as much as possible except the time when writing or reading is executed on or from the disk. In this case, the reset is generally performed when writing or reading instruction is transmitted from the host 200. In this case, the reset must be done with a short period of time as compared with the case where the sleep command is received as illustrated in FIG. 3. For this reason, the power supply to the RDC 120 and the ROM 140 is cut off while the power supply to the RAM 130 is continuously maintained, in order to prevent data of the RAM 130 from being retreated.

Note that, when there is no instruction for writing or reading, the hard disk device performs unloading in which the head is retreated to a location away from the disk. When there is an instruction for writing or reading, the hard disk device performs loading in which the head is moved onto the disk.

In the flowchart illustrated in FIG. 4, first it is checked whether or not there is an instruction of writing (W)/reading (R) (step S201). When there is no instruction, the power supply to the RDC 120 is cut off (step S202) and the head is retreated (unloaded) (step S203). When the retreat of the head is completed (step S204), the power supply to the ROM 140 is cut off (step S205).

Next, upon reception of a command from the host 200 (step S206), power is supplied to the ROM 140 (step S207), and recovery (loading) of the head is started (step S208). When the recovery of the head is completed (step S209), the recovery is notified to the host 200 (step S210).

In this case, the power supply to the RDC 120 and the ROM 140 is cut off while the power supply to the RAM 130 is continuously maintained. Accordingly, although power consumption is not reduced as much as the case where the sleep command is received as described with reference to FIG. 3, data recovery to the RAM 130 is unnecessary, thus making it possible to load the head at high speed.

Hereinafter, several modifications will be described.

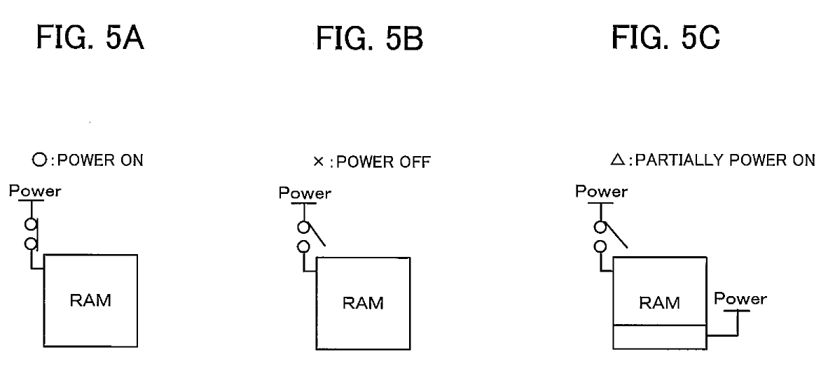

FIGS. 5A to 5C are views showing a configuration of power supply cutoff of a RAM.

FIGS. 5A and 5B illustrate a configuration in which the power supply to the entire RAM is ON/OFF, and this is the same configuration as that employed in the LSI 100 illustrated in FIG. 1.

By contrast, FIG. 5C illustrates a configuration in which the RAM is divided into two regions, one of the two regions has a switch element for power ON/OFF to maintain a power-on state in the other part of the region.

In this case, it is possible to place a boot program in the region where the power-on state of the RAM is maintained.

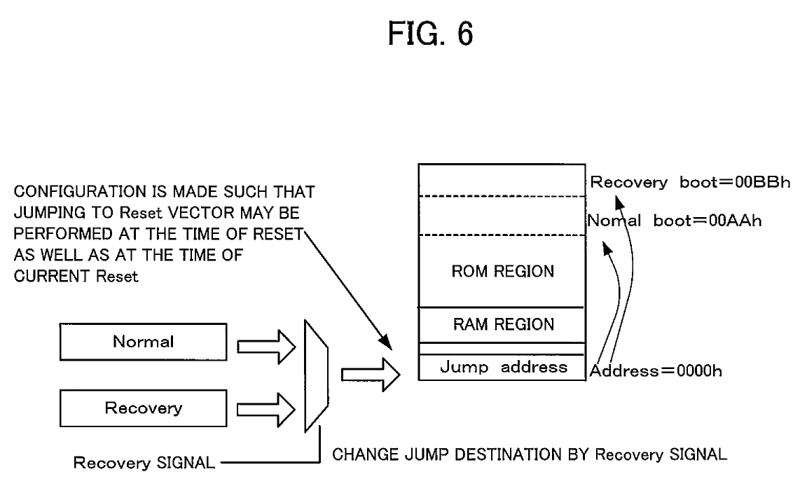

FIG. 6 is an explanatory view of rewriting a region where a boot address is stored.

An address of 0000h is referenced at the time of booting. Here, at the time just before the power supply is cut off, content of the address 0000h is rewritten to a head address of a boot program used when the power supply is recovered. At the time just after the power supply is recovered, the content of the address 0000h is rewritten to a head address of a boot program used when the normal reset operation is performed. Thereby, it is possible to execute different boot programs at the time of the normal reset operation and at the time of the recovery after power supply cutoff.

The following specific modes can be given as a method for resetting after the power supply is cut off.

(Resetting Method)

Address Jump

A method in which power is supplied to a power supply cutoff region including a reset code storage region in hardware on the basis of a reset command and then jumping to a head of an address of the reset code is performed to thereby achieve resetting without including the reset code storage regions as described by the following items (2) to (4). See an address jump system in FIG. 6 for details.

The power supply to the ROM in hardware makes it possible to jump to the same address as that at the time of the normal booting without changing a jump destination and to perform the same processing as that generally performed.

Non-Volatile Memory

A method in which a reset code is stored in a non-volatile memory (for example, ROM 140 illustrated in FIG. 1).

Volatile Memory

A method in which a RAM whose power is not cut off is provided, and a reset code is stored in the RAM to recognize by polling that an instruction for resetting is given.

Volatile Memory

A method in which power supply to a partial region of the RAM is not cut off (see FIGS. 5A to 5C), and a reset code is stored in the region to recognize by polling that an instruction for resetting is given.

Interrupt

A method in which power supply to an entire or partial region of the RAM is not cut off, and a reset code is stored therein to perform the reset operation by using an interrupt.

Table 1 includes various modes of power supply cutoff and the advantages and disadvantages in the various configurations including the mode in FIG. 5C.

TABLE 1

| | | | | Data | Resetting | | Resetting | |
|---|---|---|---|---|---|---|---|---|
| | | ROM | RAM | Retreat | Method | Recommendation | Time | Effect |
| Power | A | x | ∘ | Unnecessary | 1, 2, 3, 4, 5 | 5 | Short | Small |
| | B | x | Δ | Necessary | 1, 2, 3, 4, 5 | 5 | Middle | ↓ |
| | | | | (Partially) | | | | |
| | C | Δ | Δ | Necessary | 1, 2, 3, 4, 5 | 5 | Middle | |
| | | | | (Partially) | | | | |
| | D | ∘ | x | Necessary | 1, 2, 3 | 2.3 | Long | |
| | E | Δ | x | Necessary | 1, 2, 3 | 2.3 | Long | |
| | F | x | x | Necessary | 1, 2, 3 | 1 | Long | Large |

∘: Power ON,
x: Power OFF,
Δ: Partially Power ON (See FIG. 5C)

Regarding A to C, power is supplied to the RAM, and therefore it is possible to perform handling by an interrupt in the resetting method (5). Handling is performed by an interrupt, thereby making it possible to simplify and speed up the reset processing (even as firmware).

Regarding D and E, no power is supplied to the RAM, and therefore a reset code has to be stored in the ROM. The method (1) may also be employed, but an additional circuit for the method (1) is needed.

Regarding F, if the method (1) can be employed by an additional circuit, this is the simplest method.

In a case where no data access is performed to the RDC as illustrated in FIGS. 1 to 4, the RDC is included as an object to be powered off as well as the ROM and the RAM, thereby making it possible to achieve greater power savings.

Moreover, as illustrated in Table 2, control over operation clocks to be provided to the ROM and the RAM is combined, whereby greater power savings can be expected.

TABLE 2

| | RDC/ROM | RAM | Data Retreat |
|---|---|---|---|
| Clock | x | ∘ | Unnecessary |
| | Δ | x | Unnecessary |
| | x | x | Unnecessary |

∘: CLK ON,
x: CLK OFF,
Δ: CLK Down (=Low frequency)

According to the circuit system and the program of the above-described embodiment, it is possible to appropriately cut off power of multiple circuit blocks according to the various conditions, thereby satisfying functions as the circuit system and reducing power consumption by power cutoff.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A circuit system comprising:
a plurality of circuit blocks each of which operates upon reception of power;
a plurality of switch elements which are provided respectively to the plurality of circuit blocks, and each of which supplies and cuts off power to the corresponding circuit block upon reception of control; and
a power control unit that controls each of the plurality of switch elements to cause the switch element to supply and cut off power to the corresponding circuit block.

2. The circuit system according to claim 1, further comprising a data retreat memory, wherein
one of the plurality of circuit blocks is a volatile memory, and
the power control unit cuts off power supply to the volatile memory after retreating data stored in the volatile memory to the data retreat memory, and recovers the data retreated to the data retreat memory to the volatile memory after restarting power supply to the volatile memory.

3. The circuit system according to claim 2, further comprising:
a CPU that executes a program; and
a DMA that transfers data between the volatile memory and the data retreat memory without intermediation of the CPU, wherein
the power control unit is a function that is achieved by the program being executed by the CPU, and causes the DMA to transfer data between the volatile memory and the data retreat memory in association with the power supply and cutoff to the volatile memory.

4. The circuit system according to claim 1, wherein the power control unit includes a plurality of power cutoff modes each having a different combination of a circuit block that cuts off power supply and a circuit block that continues power supply among the plurality of circuit blocks.

5. The circuit system according to claim 4, wherein the power control unit executes a first power cutoff mode among the plurality of power cutoff modes on the basis of an instruction from an external section, and executes a second power cutoff mode in which time required for an operation recovery at the time of restarting power supply is shorter than that in the first power cutoff mode, among the plurality of power cutoff modes in accordance with a condition of the circuit system.

6. The circuit system according to claim 1, wherein the plurality of circuit blocks, the plurality of switch elements and the power control unit are included in one integrated circuit package.

7. A program storage device storing a program executed by a CPU in a circuit system including: the CPU that executes the program; a plurality of circuit blocks each of which operates upon reception of power; and a plurality of switch elements which are provided respectively to the plurality of circuit blocks and each of which supplies and cuts off power to the corresponding circuit block upon reception of control, wherein
the CPU is caused to control each of the plurality of switch elements to cause the switch element to supply and cut off power to the corresponding circuit block.

8. The program storage device according to claim 7, wherein
the circuit system further includes a data retreat memory,
one of the plurality of circuit blocks is a volatile memory, and
the program causes the CPU to cut off power supply to the volatile memory after data stored in the volatile memory is retreated to the data retreat memory, and recover the data retreated to the data retreat memory to the volatile memory after power supply to the volatile memory is restarted.

9. The program storage device according to claim 8, wherein
the circuit system further includes a DMA that transfers data between the volatile memory and the data retreat memory without intermediation of the CPU, and
the program is executed by the CPU to cause the DMA to transfer data between the volatile memory and the data retreat memory in association with the power supply and cutoff to the volatile memory.

10. The program storage device according to claim 7, wherein
the program causes the CPU to control the power supply and cutoff by a plurality of power cutoff modes each having a different combination of a circuit block that cuts off power supply and a circuit block that continues power supply among the plurality of circuit blocks.

11. The program storage device according to claim 10, wherein
the program causes the CPU to execute a first power cutoff mode among the plurality of power cutoff modes on the basis of an instruction from an external section, and execute a second power cutoff mode in which time required for an operation recovery at the time of restarting power supply is shorter than that in the first power cutoff mode, among the plurality of power cutoff modes in accordance with a condition of the circuit system.
